(19) United States
(12) Patent Application Publication
(10) Pub. No.: US 2026/0216686 A1
(43) Pub. Date: Jul. 30, 2026

(54) SEGMENTED REACTOR FOR HYDROTHERMAL SYNTHESIS IN DESULFURIZATION GYPSUM QUALITY IMPROVEMENT

(71) Applicant: Xi'an Jiaotong University, Xi'an (CN)

(72) Inventors: Yanhui Li, Xi'an (CN); Yinan Zhang, Xi'an (CN); Fengxiao Hou, Xi'an (CN); Zhihong Yu, Xi'an (CN); Shaoming Ding, Xi'an (CN); Pengfei Gao, Xi'an (CN); Zhouyang Bai, Xi'an (CN)

(21) Appl. No.: 19/406,955

(22) Filed: Dec. 3, 2025

(30) Foreign Application Priority Data
Jan. 25, 2025 (CN) 2025101203660

(51) Int. Cl. B01J 19/20; B01J 3/04; B01J 19/00

(52) U.S. Cl. CPC B01J 19/20; B01J 3/04; B01J 19/0013; B01J 19/0066

(57) ABSTRACT

A segmented reactor for hydrothermal synthesis in desulfurization gypsum quality improvement is provided, including a mixing and incubation device and a segmented pressurized reaction device sequentially connected and assembled in that order. The mixing and incubation device includes a premixing reactor equipped with a steam-injection feed inlet and a high-speed stirring and mixing component. The segmented pressurized reaction device includes a pressurized reactor, a material tumbling, dispersing and conveying component, and a steam spray component. The segmented pressurized reactor is provided with a rotatable cylinder defining a primary reaction zone and a residual reaction zone. A distribution density of steam injection nozzles in the primary reaction zone is greater than that in the residual reaction zone. On the basis of reducing energy consumption, full mixing and reaction of the gypsum slurry inside the segmented pressurized reactor are realized, addressing the issues of traditional autoclave and high-pressure aqueous solution methods.

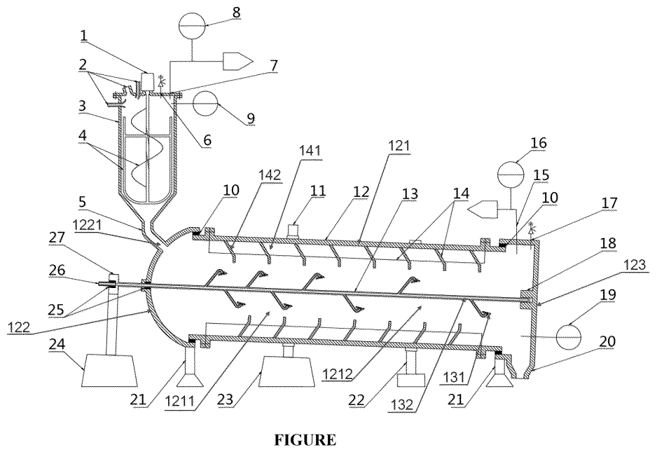

### CROSS-REFERENCE TO RELATED APPLICATION

This application claims priority to Chinese patent application No. 202510120366.0, filed to China National Intellectual Property Administration (CNIPA) on Jan. 25, 2025, which is herein incorporated by reference in its entirety.

### TECHNICAL FIELD

The disclosure relates to the field of desulfurization gypsum quality improvement technologies, and more particularly to a segmented reactor for hydrothermal synthesis in desulfurization gypsum quality improvement.

### BACKGROUND

Desulfurization gypsum is a solid waste generated during the desulfurization process of coal-fired power plants. Its main component is calcium sulfate dihydrate, which is similar to natural gypsum. The production of the desulfurization gypsum has increased significantly with the rapid development of industry. The disposal methods of stacking and landfilling in the related art have led to a continuous accumulation of stockpiles, which not only occupies large amounts of land resources but also causes serious pollution to groundwater and the environment. The recycling and resource utilization of the desulfurization gypsum can create economic value while reducing the emission and accumulation of solid waste, decreasing the mining and consumption of natural gypsum resources, and conserving natural resources.

Compared with natural gypsum, the desulfurization gypsum contains more impurities, which limits its direct use in many material fields. In particular, chloride ions present in desulfurization gypsum lead to a reduction in the strength of the converted product, severely limiting its high-value applications. Therefore, quality improvement treatment is required for the desulfurization gypsum to enable better resource utilization. The most promising and beneficial pathway for the resource utilization of the desulfurization gypsum is its quality improvement to produce high-strength, high-performance, and high-value-added α-hemihydrate gypsum, with the chemical formula α-CaSO₄·0.5H₂O. The α-hemihydrate gypsum can be obtained through the dissolution-crystallization mechanism of dihydrate gypsum. The specific method mainly involves subjecting the dihydrate gypsum to suitable thermal conditions in a saturated water vapor medium or aqueous solution to remove 1.5 molecules of crystal water from the crystal lattice, forming nascent hemihydrate gypsum that dissolves in a water-surrounded environment. When the concentration of liquid-phase hemihydrate gypsum reaches saturation, the liquid hemihydrate gypsum rapidly crystallizes, forming coarse and dense α-hemihydrate gypsum crystals. Subcritical water, defined as water heated above its boiling point but below its critical point, exhibits unique physicochemical properties, including reduced dielectric constant, enhanced ion solubility, and improved mass transfer capability. These characteristics significantly promote the dissolution of impurities such as chloride ions while facilitating the controlled dissolution and recrystallization of calcium sulfate dihydrate. In the subcritical hydrothermal environment, the dissolution-crystallization process is accelerated, and chloride ions are effectively leached into the aqueous phase due to their high solubility in subcritical water, thereby minimizing their incorporation into the growing α-hemihydrate crystal lattice. This results in purer, higher-strength α-hemihydrate gypsum with markedly improved performance.

Specifically, by precisely controlling temperature, pressure, and reaction time within the subcritical water regime, the present invention enables simultaneous impurity removal and phase transformation, overcoming the limitations of conventional hydrothermal methods. This subcritical hydrothermal approach not only enhances the purity and mechanical properties of the resulting α-hemihydrate gypsum but also provides an energy-efficient and environmentally benign route for the high-value utilization of desulfurization gypsum. The mainstream process methods for the desulfurization gypsum quality improvement to produce the α-hemihydrate gypsum are the autoclave method and the high-pressure aqueous solution method. The autoclave method involves grinding the desulfurization gypsum into powder, placing the powder in an autoclave, introducing high-pressure saturated steam, and maintaining certain temperature and pressure conditions for a period of time to complete the crystal transformation into the α-hemihydrate gypsum. The high-pressure aqueous solution method involves mixing the desulfurization gypsum, water, and crystal-control agents into a slurry, placing the slurry in a high-pressure reactor, stirring and heating to 120-160° C. under a pressure of 0.2-0.8 megapascals (MPa), and reacting for a period of time to complete dehydration and crystal transformation, yielding the α-hemihydrate gypsum. However, when using the autoclave method or the high-pressure aqueous solution method for desulfurization gypsum quality improvement, the reaction process of converting the dihydrate gypsum into the α-hemihydrate gypsum via dissolution-crystallization is highly sensitive to reaction conditions such as temperature and time. The local uniformity and crystallinity of the α-hemihydrate gypsum growth fluctuate with changes in reaction temperature and time. Additionally, the desulfurization gypsum slurry is thick and prone to sedimentation and agglomeration, which affects heat transfer and the local reaction time and heating conditions. As a result, the reaction process and product performance are difficult to control, leading to significant product quality fluctuations, relatively low strength, high energy consumption, and low product added value, which is unfavorable for commercial promotion.

In addition, the equipment used in the autoclave and high-pressure aqueous solution methods for the desulfurization gypsum quality improvement to produce the α-hemihydrate gypsum in the related art suffers from high energy consumption, long preparation times, low reaction efficiency, and poor economic viability of the reaction system, making it unsuitable for large-scale continuous production.

### SUMMARY

To address issues of significant fluctuations in product quality, relatively low strength, high energy consumption, and low reaction efficiency associated with autoclave and high-pressure aqueous solution methods in the related art to produce α-hemihydrate gypsum, the disclosure aims to provide a segmented reactor for hydrothermal synthesis in desulfurization gypsum quality improvement.

Technical solutions of the disclosure are as follows.

The disclosure provides a segmented reactor for hydrothermal synthesis in desulfurization gypsum quality improvement, including a mixing and incubation device and a segmented pressurized reaction device sequentially connected and assembled in that order. The mixing and incubation device includes a premixing reactor, a high-speed stirring and mixing component, and a material conveying and dispersing component. The premixing reactor defines a steam-injection feed inlet and the premixing reactor is configured to preheat and mix steam with reaction feedstock. The high-speed stirring and mixing component is disposed within the premixing reactor and configured to uniformly mix a gypsum slurry with the steam. The material conveying and dispersing component is disposed at a tail end (i.e., discharge end) of the premixing reactor and configured to convey the gypsum slurry from the premixing reactor to the pressurized reactor while maintaining in a uniformly mixed state.

The segmented pressurized reaction device includes the pressurized reactor, a material tumbling, dispersing and conveying component, and a steam spray component. The pressurized reactor has a rotatable cylinder, and an interior of the rotatable cylinder defines a primary reaction zone and a residual reaction zone. The material tumbling, dispersing and conveying component is fixed to an inner wall of the rotatable cylinder and configured to tumble, disperse, and convey the gypsum slurry. The steam spray component is rotatably mounted along an axial direction of the pressurized reactor, the steam spray component includes multiple steam injection nozzles arranged along a movement direction of the gypsum slurry, with a higher distribution density of steam injection nozzles in the primary reaction zone than in the residual reaction zone.

The segmented hydrothermal synthesis reactor for hydrothermal synthesis in desulfurization gypsum quality improvement mainly consists of two stages: the first stage is the mixing and incubation device, and the second stage is the segmented pressurized reaction device.

The mixing and incubation device focuses on preheating and mixing before the reaction. By thoroughly mixing prior to the reaction, it ensures a homogeneous state before the reaction starts, thereby controlling the uniformity of reaction temperature and time during the process. Additionally, by premixing reaction materials and steam through the mixing and incubation device, the total reaction time can be reduced, enhancing reaction efficiency and achieving the goal of reducing energy consumption.

The segmented pressurized reaction device focuses on the reaction itself, providing ample space for continuous feeding to ensure sufficient reaction time. By coordinating the pressurized reactor, the material tumbling, dispersing and conveying component, and the steam spray component, it ensures thorough mixing of steam and slurry, preventing sedimentation and agglomeration of gypsum slurry. Since the reaction is endothermic, local temperature drops may occur during the process, and thorough mixing helps ensure even heating.

Through the coordination of the mixing and incubation device and the segmented pressurized reaction device, the disclosure effectively controls reaction temperature and time, achieving thorough mixing and reaction of the gypsum slurry within the pressurized reactor, avoiding agglomeration and uneven mixing of the gypsum slurry, which could lead to incomplete reactions and affect product quality. It solves the problems of significant fluctuations in product quality, relatively low strength, high energy consumption, and low reaction efficiency associated with the autoclave and high-pressure aqueous solution methods in the related art to produce the α-hemihydrate gypsum.

By adjusting the distribution density of steam injection nozzles in the primary and residual reaction zones, the segmented pressurized reaction device matches the reaction rate of the gypsum slurry within the pressurized reactor. Specifically, the higher distribution density of steam injection nozzles in the primary reaction zone compared to the residual reaction zone allows for dense steam spraying in the primary reaction zone, breaking up agglomerated slurry and ensuring thorough contact with steam. In the residual reaction zone, where most reactions are complete, fewer steam injections are needed, thus improving steam utilization.

Moreover, the disclosure utilizes the material tumbling, dispersing and conveying component to help tumble and disperse the gypsum slurry within the rotatable cylinder, further breaking up agglomerated slurry and promoting reactions with steam. At the same time, during the process of tumbling, dispersing and mixing the gypsum slurry, internal helical ribbons guide the gypsum slurry to convey along its movement direction.

According to the disclosure, the gypsum slurry in the rotatable cylinder is subjected to tumbling, dispersing, mixing and heat treatment in different zones, so that the full mixing reaction of the gypsum slurry in the pressurized reactor can be realized on the basis of reducing energy consumption, and the product quality can be prevented from being affected due to insufficient reaction caused by agglomeration and uneven mixing of the gypsum slurry.

In an embodiment, a height-diameter ratio of the premixing reactor is in a range of 3:2 to 1:1.

According to the disclosure, the premixing reactor is of a slim and tall structure, and the height-diameter ratio is in a range of 3:2 to 1:1, so that the narrow and slender space can ensure the rapid contact of steam and gypsum slurry in a very short time.

In an embodiment, the high-speed stirring and mixing component realizes axial and circumferential mixing through down-pressing and frame-type stirring and mixing structures with high rotation speed, ensures rapid mixing within a short time of about 3 minutes to 10 minutes, and fully preheats before the reaction to ensure that the slurry is evenly heated during the reaction.

In an embodiment, a rotation direction of the steam spray component is opposite to the rotation direction of the rotatable cylinder.

In the disclosure, an accumulation groove of the gypsum slurry is formed between the material tumbling, dispersing and conveying component and the inner wall of the rotatable cylinder. Because the rotation direction of the steam spray component is opposite to that of the rotatable cylinder, multiple steam injection nozzles of the steam spray component can fully contact with the gypsum slurry in the accumulation groove, and the sprayed steam can break the agglomerated slurry and make the slurry react with the fully contacted steam.

In an embodiment, the material tumbling, dispersing and conveying component includes:
multiple baffles and multiple internal helical ribbons.

The multiple baffles are circumferentially arranged on the inner wall of the rotatable cylinder. The multiple internal helical ribbons are arranged on opposite side walls of the baffles correspondingly along the movement direction of the gypsum slurry, and are configured to convey the gypsum slurry in the rotatable cylinder along the movement direction of the gypsum slurry.

In the disclosure, the accumulation groove of the gypsum slurry is formed between the baffles and the inner wall of the rotatable cylinder, which is beneficial to tumbling, dispersing and mixing the gypsum slurry in the rotatable cylinder. Combined with the sprayed steam, the agglomerated slurry is further broken and the slurry reacts with the fully contacted steam. The arrangement of the internal helical ribbons mainly enables the gypsum slurry to be transported along the movement direction of the gypsum slurry with the help of the guiding function of the internal helical ribbons in the process of tumbling, dispersing and mixing.

In an embodiment, the multiple internal helical ribbons are evenly spaced along the side walls of the multiple baffles. An arrangement direction of each internal helical ribbon forms an acute angle with the movement direction of the gypsum slurry. In an embodiment, the arrangement direction of each internal helical ribbon is in a range of 30°-60° with the movement direction of the gypsum slurry.

In the disclosure, the arrangement direction of each internal helical ribbon is arranged according to the rotation direction of the rotatable cylinder and the movement direction of the gypsum slurry, so that the gypsum slurry in the rotatable cylinder can be fully contacted with steam while being transported along the movement direction of the gypsum slurry, and the agglomerated slurry is broken by the steam and undergoes a reaction.

In an embodiment, the distribution density of the steam injection nozzles in the primary reaction zone is 300 millimeters per nozzle (mm/nozzle) to 600 mm/nozzle. The distribution density of the steam injection nozzles in the residual reaction zone is 1000 mm/nozzle to 1500 mm/nozzle.

In that disclosure, along the movement direction of the gypsum slurry, the rotatable cylinder is sequentially divided into the primary reaction zone and the residual reaction zone. The primary reaction zone is arranged at an end close to the mixing and inoculation device in the rotatable cylinder, and the residual reaction zone is arranged at an end facing away from the mixing and inoculation device in the rotatable cylinder.

The disclosure can match the reaction rate of the gypsum slurry in the pressurized reactor by adjusting the distribution density of the steam injection nozzles in the primary reaction zone and the residual reaction zone. The distribution density of steam injection nozzles in the primary reaction zone is 300 mm/nozzle to 600 mm/nozzle, and the distribution density in the residual reaction zone is 1000 mm/nozzle to 1500 mm/nozzle. Because the reaction rate is from fast to slow from the front end to the back end of the pressurized reactor, the reaction mainly occurs in the primary reaction zone, and the dense steam injection nozzles can meet the required amount of the reaction. At the same time, the dense steam spray in the primary reaction zone can break up the agglomerated slurry and make it fully contact with steam for reaction. In the residual reaction zone, most of the reactions have been completed, and only a small amount of steam can meet the reaction requirements. The sparse steam injection nozzle arrangement in the residual reaction zone can improve the steam utilization rate.

In an embodiment, the steam spray component includes a steam conduit, an end of the steam conduit is rotatably connected to an end of the pressurized reactor, another end of the steam conduit is dynamically sealed to another end of the pressurized reactor, and the another end of the steam conduit extends outwardly from the pressurized reactor. The multiple steam injection nozzles are alternately arranged on the steam conduit in an arrangement mode with a circumferential angle of 45° and connected to the steam conduit.

In an embodiment, along the movement direction of the gypsum slurry, a distribution density of the multiple steam injection nozzles gradually decreases.

Therefore, by adjusting the distribution density of the steam injection nozzles in the primary reaction zone and the residual reaction zone, the reaction rate of the gypsum slurry in the pressurized reactor can be matched to improve the steam utilization rate.

In an embodiment, the segmented reactor for hydrothermal synthesis in desulfurization gypsum quality improvement further includes a drive device, and the drive device includes a first drive unit and a second drive unit.

The first drive unit is disposed on a side of the rotatable cylinder and configured to rotate the rotatable cylinder. The second drive unit is disposed on an external portion of the steam spray component extending out of the pressurized reactor, and configured to rotate the steam spray component.

In an embodiment, the pressurized reactor comprises a feed end cap and a discharge end cap respectively mounted at opposite ends of the rotatable cylinder and dynamically sealed to the rotatable cylinder. The feed end cap defines a feed inlet, and the discharge end cap defines a fixed discharge outlet. The material conveying and dispersing component of the mixing and incubation device is fixedly connected to the feed inlet.

In an embodiment, the feed end cap is provided with a second dynamic sealing component, and the discharge end cap is provided with a support bearing component. An end of the steam spray component is mounted on the support bearing component, and another end of the steam spray component extends through the second dynamic sealing component. Taking a horizontal direction as a reference, an included angle between an axial orientation of the pressurized reactor and the horizontal direction is an acute angle. In an embodiment, the included angle between the axial direction and the horizontal direction of the pressurized reactor is 10°-30°.

The disclosure has the beneficial effects as follows.
1. The disclosure can effectively control the reaction temperature and time through the cooperation of the mixing and incubation device and the segmented pressurized reaction device, and realize the full mixing reaction of the gypsum slurry in the pressurized reactor on the basis of reducing energy consumption, so as to avoid the influence of insufficient reaction on the product quality due to the agglomeration and uneven mixing of the gypsum slurry. It solves the problems of significant fluctuations in product quality, relatively low strength, high energy consumption, and low reaction efficiency associated with the autoclave and high-pressure aqueous solution methods in the related art to produce α-hemihydrate gypsum.
2. The disclosure can match the reaction rate of the gypsum slurry in the pressurized reactor mainly by adjusting the distribution density of the steam injection nozzles in the primary reaction zone and the residual reaction zone. The distribution density of the steam injection nozzles in the primary reaction zone is greater than that of the steam injection nozzles in the residual reaction zone, so that dense steam spaying can be formed in the primary reaction zone to break the agglomerated slurry and make it fully contact with steam for reaction. In the residual reaction zone, because most of the reactions have been completed, only a small amount of steam can meet the reaction requirements, and the sparse steam injection nozzle arrangement in the residual reaction zone can improve the steam utilization rate.
3. The material tumbling, dispersing and conveying component can help to tumble, disperse and mix the gypsum slurry in the rotatable cylinder, and cooperate with dense steam spaying to further break the agglomerated slurry, and make the slurry react with the fully contacted steam. At the same time, during the tumbling, dispersing and mixing process, the gypsum slurry can be transported along the movement direction of the gypsum slurry with the help of the guiding function of the internal helical ribbons.
4. The segmented reactor for hydrothermal synthesis in desulfurization gypsum quality improvement facilitates nucleation and growth of α-hemihydrate gypsum crystals, ensuring uniform crystal morphology and consistent product quality, thereby enabling the production of products with higher compressive strength.

### BRIEF DESCRIPTION OF DRAWING

FIGURE is a structural cross-sectional view of a segmented reactor for hydrothermal synthesis in desulfurization gypsum quality improvement according to an embodiment of the disclosure.

### DESCRIPTION OF REFERENCE SIGNS

1. agitator drive unit; 2. steam-injection feed inlet; 3. premixing reactor; 4. high-speed stirring and mixing component; 5. material conveying and dispersing component; 6. first safety valve; 7. first exhaust unit; 8. first pressure monitoring and control unit; 9. first temperature monitoring and control unit; 10. first dynamic sealing component; 11. power gear; 12. pressurized reactor; 121. rotatable cylinder; 1211. primary reaction zone; 1212. residual reaction zone; 122. feed end cap; 1221. feed inlet; 123. discharge end cap; 13. steam spray component; 131. steam injection nozzle; 132. steam conduit; 14. material tumbling, dispersing, and conveying component; 141. baffle; 142. internal helical ribbon; 15. second exhaust unit; 16. second pressure monitoring and control unit; 17. second safety valve; 18. support bearing component; 19. second temperature monitoring and control unit; 20. fixed discharge outlet; 21. fixed support structure; 22. rolling support structure; 23. first drive unit; 24. second drive unit; 25. second dynamic sealing component; 26. steam inlet; 27. support sealing structure.

### DETAILED DESCRIPTION OF EMBODIMENTS

In order to make objectives, technical solutions, and advantages of the disclosure clearer and more comprehensible, the disclosure will be further described in detail below with reference to specific embodiments. It should be understood that the specific embodiments described herein are provided solely for illustrative purposes and are not intended to limit the scope of the disclosure.

All other embodiments obtained by those skilled in the art without inventive effort based on the embodiments of the disclosure shall fall within the scope of protection of the disclosure.

The technical solutions of the disclosure will be further explained below through specific embodiments. Unless otherwise specified, methods used in the following embodiments are conventional methods. Unless otherwise specified, reagents and materials used are commercially available.

As shown in the FIGURE, a segmented reactor for hydrothermal synthesis in desulfurization gypsum quality improvement includes a mixing and incubation device and a segmented pressurized reaction device sequentially connected and assembled in that order.

The mixing and incubation device includes: a premixing reactor 3, a high-speed stirring and mixing component 4, and a material conveying and dispersing component 5. The premixing reactor 3 is provided with a steam-injection feed inlet 2 and configured to preheat and mix steam with reaction feedstock. The high-speed stirring and mixing component 4 is disposed inside the premixing reactor 3 and configured to uniformly mix a gypsum slurry with the steam. The material conveying and dispersing component 5 is disposed at a tail end of the premixing reactor 3 and configured to convey the gypsum slurry from the premixing reactor 3 to a pressurized reactor 12 while maintaining in a uniformly mixed state.

The segmented pressurized reaction device includes a pressurized reactor 12, a steam spray component 13, and a material tumbling, dispersing and conveying component 14. The pressurized reactor 12 has a rotatable cylinder 121 and an interior of the rotatable cylinder 121 defines a primary reaction zone 1211 and a residual reaction zone 1212. The material tumbling, dispersing and conveying component 14 is fixed to an inner wall of the rotatable cylinder 121 for tumbling, dispersing, and conveying the gypsum slurry. The steam spray component 13 is rotatably mounted along an axial direction of the pressurized reactor 12. The steam spray component 13 includes multiple steam injection nozzles 131 along a movement direction of the gypsum slurry, and the number of the steam injection nozzles 131 in the primary reaction zone 1211 is greater than that in the residual reaction zone 1212.

Specifically, the segmented reactor for hydrothermal synthesis in desulfurization gypsum quality improvement according to the embodiment of the disclosure is mainly divided into a first stage and a second stage, the first stage is the mixing and incubation device, and the second stage is the segmented pressurized reaction device.

The mixing and incubation device focuses on preheating and mixing before the reaction. By thoroughly mixing prior to the reaction, it ensures a homogeneous state before the reaction starts, thereby controlling the uniformity of reaction temperature and time during the process. Additionally, by premixing reaction materials and steam through the mixing and incubation device, the total reaction time can be reduced, enhancing reaction efficiency and achieving the goal of reducing energy consumption.

The segmented pressurized reaction device focuses on the reaction itself, providing ample space for continuous feeding to ensure sufficient reaction time. By coordinating the pressurized reactor, the material tumbling, dispersing and conveying component, and the steam spray component, it ensures thorough mixing of steam and slurry, preventing sedimentation and agglomeration of gypsum slurry. Since the reaction is endothermic, local temperature drops may occur during the process, and thorough mixing helps ensure even heating.

Specifically, in the embodiment of the disclosure, through the coordination of the mixing and incubation device and the segmented pressurized reaction device, the disclosure effectively controls reaction temperature and time, achieving thorough mixing and reaction of the gypsum slurry within the pressurized reactor, avoiding agglomeration and uneven mixing of the gypsum slurry, which could lead to incomplete reactions and affect product quality. It solves the problems of significant fluctuations in product quality, relatively low strength, high energy consumption, and low reaction efficiency associated with the autoclave and high-pressure aqueous solution methods in the related art to produce the α-hemihydrate gypsum.

Specifically, by adjusting the distribution density of steam injection nozzles 131 in the primary and residual reaction zone 1212, the segmented pressurized reaction device of the embodiment of the disclosure matches the reaction rate of the gypsum slurry within the pressurized reactor. Specifically, the higher distribution density of steam injection nozzles 131 in the primary reaction zone 1211 compared to the residual reaction zone 1212 allows for dense steam spraying in the primary reaction zone 1211, breaking up agglomerated slurry and ensuring thorough contact with steam. In the residual reaction zone 1212, where most reactions are complete, fewer steam injections are needed, thus improving steam utilization.

Specifically, the embodiment of the disclosure utilizes the material tumbling, dispersing and conveying component to help tumble and disperse the gypsum slurry within the rotatable cylinder 121, further breaking up agglomerated slurry and promoting reactions with steam. At the same time, during the process of tumbling, dispersing and mixing the gypsum slurry, internal helical ribbons 142 guide the gypsum slurry to convey along its movement direction.

Specifically, in the embodiment of the disclosure, the gypsum slurry in the rotatable cylinder 121 is subjected to tumbling, dispersing, mixing and heat treatment in different zones, so that the full mixing reaction of the gypsum slurry in the pressurized reactor can be realized on the basis of reducing energy consumption, and the product quality can be prevented from being affected due to insufficient reaction caused by agglomeration and uneven mixing of the gypsum slurry.

Based on the above implementation, in a specific embodiment, a height-diameter ratio of the premixing reactor 3 is in a range of 3:2 to 1:1.

Specifically, in the embodiment of the disclosure, the premixing reactor is of a slim and tall structure, and the height-diameter ratio is in a range of 3:2 to 1:1, so that the narrow and slender space can ensure the rapid contact of steam and gypsum slurry in a very short time.

Based on the above implementation, in a specific embodiment, the high-speed stirring and mixing component 4 employs stirring and mixing structures with high rotation speed. The stirring and mixing structures are down-pressing and frame-type stirring and mixing structures to achieve both axial and circumferential mixing.

Specifically, the high-speed stirring and mixing component 4 of the embodiment of the disclosure realizes the axial and circumferential mixing through the down-pressing and frame-type stirring and mixing structures with high rotation speed, ensures rapid mixing within a short time of about 3 minutes to 10 minutes, and fully preheats before the reaction to ensure that the slurry is evenly heated during the reaction.

Based on the above implementation, in a specific embodiment, a rotation direction of the steam spray component 13 is opposite to that of the rotatable cylinder 121.

Specifically, an accumulation groove of the gypsum slurry is formed between the material tumbling, dispersing and conveying component and the inner wall of the rotatable cylinder 121. Because the rotation direction of the steam spray component is opposite to that of the rotatable cylinder 121, multiple steam injection nozzles 131 of the steam spray component can fully contact with the gypsum slurry in the accumulation groove, and the sprayed steam can break the agglomerated slurry and make the slurry react with the fully contacted steam.

Based on the above implementation, in a specific embodiment, the material tumbling, dispersing and conveying component 14 includes multiple baffles 141 and multiple internal helical ribbons 142.

The multiple baffles 141 are circumferentially arranged on the inner wall of the rotatable cylinder 121.

The multiple internal helical ribbons 142 are arranged on opposite side walls of the baffles 141 correspondingly along the movement direction of the gypsum slurry, and are configured to convey the gypsum slurry in the rotatable cylinder 121 along the movement direction of the gypsum slurry.

Specifically, the accumulation groove of the gypsum slurry is formed between the baffles 141 and the inner wall of the rotatable cylinder 121, which is beneficial to tumbling, dispersing and mixing the gypsum slurry in the rotatable cylinder 121. Combined with the sprayed steam, the agglomerated slurry is further broken and the slurry reacts with the fully contacted steam. The arrangement of the internal helical ribbons 142 mainly enables the gypsum slurry to be transported along the movement direction of the gypsum slurry with the help of the guiding function of the internal helical ribbons 142 in the process of tumbling, dispersing and mixing.

Specifically, the embodiment of the disclosure fully mixes the slurry using the mixing and incubation device, and then applies rolling agitation via internal helical ribbons 142 in the segmented pressurized reaction device. Six baffles 141 tumble and disperse the desulfurization gypsum slurry, while the centrally rotating the steam spray component ensures uniform steam distribution, thoroughly mixing steam with the desulfurization gypsum slurry and facilitating nucleation and growth of α-hemihydrate gypsum crystals.

The segmented reactor for hydrothermal synthesis in desulfurization gypsum quality improvement according to the embodiment of the disclosure enables complete conversion reactions. By combining segmented premixing and various stirring methods, it ensures thorough contact and reaction between steam and slurry, offering a practical and feasible hydrothermal synthesis equipment for producing α-hemihydrate gypsum for the quality improvement and recycling of desulfurization gypsum.

Based on the above implementation, in a specific embodiment, the multiple internal helical ribbons 142 are evenly spaced on the side walls of their corresponding baffles 141. An arrangement direction of each internal helical ribbon 142 forms an acute angle with the movement direction of the gypsum slurry. In an embodiment, the arrangement direction of each internal helical ribbon 142 is in a range of 30°-60° with the movement direction of the gypsum slurry.

Specifically, the arrangement direction of each internal helical ribbon 142 is arranged according to the rotation direction of the rotatable cylinder 121 and the movement direction of the gypsum slurry, so that the gypsum slurry in the rotatable cylinder 121 can be fully contacted with steam while being transported along the movement direction of the gypsum slurry, and the agglomerated slurry is broken by the steam and undergoes a reaction.

Based on the above implementation, in a specific embodiment, the distribution density of the steam injection nozzles 131 in the primary reaction zone 1211 is 300 mm/nozzle to 600 mm/nozzle. The distribution density of the steam injection nozzles 131 in the residual reaction zone 1212 is 1000 mm/nozzle to 1500 mm/nozzle.

Specifically, along the movement direction of the gypsum slurry, the rotatable cylinder 121 is sequentially divided into the primary reaction zone 1211 and the residual reaction zone 1212. The primary reaction zone 1211 is arranged at an end close to the mixing and inoculation device in the rotatable cylinder 121, and the residual reaction zone 1212 is arranged at an end facing away from the mixing and inoculation device in the rotatable cylinder 121.

Specifically, the embodiment of the disclosure can match the reaction rate of the gypsum slurry in the pressurized reactor by adjusting the distribution density of the steam injection nozzles 131 in the primary reaction zone 1211 and the residual reaction zone 1212. The distribution density of steam injection nozzles 131 in the primary reaction zone 1211 is 300 mm/nozzle to 600 mm/nozzle, and the distribution density in the residual reaction zone 1212 is 1000 mm/nozzle to 1500 mm/nozzle. Because the reaction rate is from fast to slow from the front end to the back end of the pressurized reactor, the reaction mainly occurs in the primary reaction zone 1211, and the dense steam injection nozzles 131 can meet the required amount of the reaction. At the same time, the dense steam spray in the primary reaction zone 1211 can break up the agglomerated slurry and make it fully contact with steam for reaction. In the residual reaction zone 1212, most of the reactions have been completed, and only a small amount of steam can meet the reaction requirements. The sparse steam injection nozzle arrangement in the residual reaction zone 1212 can improve the steam utilization rate.

Based on the above implementation, in a specific embodiment, the steam spray component 13 includes a steam conduit 132, an end of the steam conduit 132 is rotatably connected to an end of the pressurized reactor 12, another end of the steam conduit 132 is dynamically sealed to another end of the pressurized reactor 12, and the another end of the steam conduit 132 extends outwardly from the pressurized reactor 12. The multiple steam injection nozzles 131 are alternately arranged on the steam conduit 132 in an arrangement mode with a circumferential angle of 45°and connected to the steam conduit 132.

Specifically, the end of the steam conduit 132 extending out of the pressurized reactor 12 serves as a steam inlet 26, which is connected externally to a steam supply system. The steam spray component 13 is mounted along the axial center of the rotatable cylinder 121 of the pressurized reactor 12 and rotates in the opposite direction to the rotatable cylinder 121, which is driven by a second drive unit 24. The steam conduit 132 extends to the rear end head and is supported by a support bearing component 18 at the rear end head. The steam conduit 132 is connected externally to the pipeline of the steam supply system via the steam inlet 26 through the second dynamic sealing component 25, as well as to the front section of the pressurized reactor 12.

Based on the above implementation, in a specific embodiment, the distribution density of the steam injection nozzles 131 gradually decreases along the movement direction of the gypsum slurry.

Specifically, the embodiment of the disclosure adjusts the distribution density of steam injection nozzles 131 in the primary and residual reaction zone 1212 to match the reaction rate of the gypsum slurry inside the pressurized reactor, thereby improving steam utilization efficiency.

Based on the above implementation, in a specific embodiment, the segmented reactor for hydrothermal synthesis in desulfurization gypsum quality improvement further includes a drive device comprising a first drive unit 23 and a second drive unit 24.

The first drive unit 23 is disposed on one side of the rotatable cylinder 121 and is capable of driving the rotatable cylinder 121 to rotate. Specifically, the first drive unit 23 is, for example, a motor. Specifically, the pressurized reactor 12 is horizontally positioned, and the rotatable cylinder 121 is rotatable. A power gear 11 is mounted at the center of the outer wall of the rotatable cylinder 121. The first drive unit 23 is equipped with a driving gear that meshes with the power gear 11, so that rotation of the driving gear by the first drive unit 23 drives the rotation of the power gear 11.

The second drive unit 24 is disposed adjacent to the portion of the steam spray component 13 that extends out of the pressurized reactor 12 and is capable of driving the steam spray component 13 to rotate.

Based on the above implementation, in a specific embodiment, the pressurized reactor 12 includes a feed end cap 122 and a discharge end cap 123, which are respectively mounted at the two ends of the rotatable cylinder 121 and dynamically sealed to the rotatable cylinder 121. The feed end cap 122 is provided with a feed inlet 1221, and the discharge end cap 123 is provided with a fixed discharge outlet 20. The mixing and incubation device includes the material conveying and dispersing component 5, which is fixedly connected to the feed inlet 1221.

Specifically, the rear side of the rotatable cylinder 121 is supported by a rolling support structure 22. Both the material conveying and dispersing component 5 at the front end and the fixed discharge outlet 20 at the rear end remain stationary. The fixed discharge outlet 20 at the rear end of the pressurized reactor 12 employs an internal funnel-type discharge design. The feed end cap 122 of the pressurized reactor 12 is connected to the rotatable cylinder 121 via a first dynamic sealing component 10 to allow relative motion, and the discharge end cap 123 is supported by a fixed support structure 21.

Based on the above implementation, in a specific embodiment, the feed end cap 122 is provided with a second dynamic sealing component 25, and the discharge end cap 123 is provided with a support bearing component 18. One end of the steam spray component 13 is mounted on the support bearing component 18, and the other end passes through the second dynamic sealing component 25. Taking a horizontal direction as a reference, an included angle between an axial orientation of the pressurized reactor 12 and the horizontal direction is an acute angle. In an embodiment, the included angle between the axial orientation of the pressurized reactor 12 and the horizontal direction is in a range of 10° to 30°.

Based on the above implementation, in a specific embodiment, the mixing and incubation device includes the premixing reactor 3. The top of the premixing reactor 3 is fitted with the steam-injection feed inlet 2. The premixing reactor 3 is provided with the high-speed stirring and mixing component 4 internally, and its lower part is connected to the pressurized reactor 12 via the material conveying and dispersing component 5.

Specifically, the steam-injection feed inlet 2 at the top of the premixing reactor 3 uses a flared steam nozzle to mix with the desulfurization gypsum slurry fed into the premixing reactor 3 by gravity, achieving initial premixing. The premixing reactor 3 has a tall and slender structure with a height-diameter ratio between 3:2 and 1:1, allowing control of slurry residence time slightly longer than the solid-phase reaction time required. The internal high-speed stirring and mixing component 4 performs axial and circumferential mixing via downward-pressing and frame-type agitators. The lower part of the premixing reactor 3 is equipped with the material conveying and dispersing component 5, which allows material to uniformly enter the pressurized reactor 12 by gravity. The mixing and incubation device is welded to the upper part of the front end head of the segmented pressurized reaction device, enabling gravity-fed dispersion of the gypsum slurry for better mixing. Temperature and pressure measurement and control devices are installed at the top of the mixing and incubation device to maintain stable and suitable reaction conditions.

Based on the above implementation, in a specific embodiment, the pressurized reactor 12 has a rotatable cylinder 121, with a counter-rotating steam spray component 13 mounted along its axial center. The interior of the rotatable cylinder 121 is equipped with the material tumbling, dispersing and conveying component 14. The desulfurization gypsum material is thrown from the premixing reactor 3 into the pressurized reactor 12 via the front-mounted material conveying and dispersing component 5, and the rear end of the pressurized reactor 12 defines the fixed discharge outlet 20.

It should be noted that the premixing reactor 3 and the pressurized reactor 12 are connected via the material conveying and dispersing component 5. The material and steam enter the premixing reactor 3 through the steam-injection feed inlet 2 at the top and undergo preliminary mixing. The premixing reactor 3 adopts the tall and slender structure with a height-diameter ratio between 3:2 and 1:1, controlling the gypsum slurry residence time to be slightly longer than the solid-phase reaction time required. An agitator drive unit 1 is mounted at the upper axial center of the premixing reactor 3. The high-speed stirring and mixing component 4 uses frame-type and downward-pressing impellers to achieve axial and circumferential mixing. After thorough mixing with steam, the material enters the pressurized reactor 12 through the lower material conveying and dispersing component 5. A first safety valve 6 is mounted at the top to ensure safe operation of the premixing reactor 3.

In one embodiment, a first temperature monitoring and control unit 9 may be installed on the upper part of the premixing reactor 3 to monitor its temperature in real time. The steam input through the steam-injection feed inlet 2 can be adjusted to maintain a constant temperature in the premixing reactor 3.

In another embodiment, a first pressure monitoring and control unit 8 and a first exhaust unit 7 may be installed on the upper part of the premixing reactor 3 to monitor and control internal pressure. In the event of a sudden pressure change, immediate pressure-control measures can be taken, facilitating process adjustment and research.

The material enters the pressurized reactor 12 uniformly via gravity through the material conveying and dispersing component 5. The pressurized reactor 12 is horizontally positioned, with its rotatable cylinder 121 rotating. The power gear 11 is welded at the center of the outer wall of the rotatable cylinder 121 and driven by the first drive unit 23. The rear side of the rotatable cylinder 121 is supported by the rolling support structure 22. Both the front material conveying and dispersing component 5 and the rear fixed discharge outlet 20 remain stationary, the front material conveying and dispersing component 5 is connected to the rotatable cylinder 121 via the first dynamic sealing component 10 and supported by the fixed support structure 21. Inside the pressurized reactor 12, the material tumbling, dispersing and conveying component 14 tumbles, disperses, and conveys the material. For example, the internal helical ribbons 142 and six evenly distributed baffles 141 are welded to the inner wall of the rotatable cylinder 121. The material is conveyed from the front to the rear of the rotatable cylinder by the internal helical ribbons 142. As the rotatable cylinder 121 rotates, the material flips under gravity and is dispersed by the baffles 141.

The steam spray component 13 is mounted along the axial center of the rotatable cylinder 121 of the pressurized reactor 12 and rotates in the opposite direction to the rotatable cylinder 121, which is driven by the second drive unit 24. The steam conduit 132 extends to the rear end head and is supported by the support bearing component 18 at the rear end head. The steam conduit 132 is connected externally to the steam supply system via the steam inlet 26 and the front section of the pressurized reactor 12 through the second dynamic sealing component 25. The steam injection nozzles 131 are alternately arranged at 45° circumferential intervals along the conduit, transitioning from dense to sparse distribution. During rotation, steam is uniformly sprayed and thoroughly mixed with the material for reaction. The rear end of the pressurized reactor 12 is connected to the fixed discharge outlet 20 via the first dynamic sealing component 10, employing an internal funnel-type discharge. A second safety valve 17 is mounted at the top of the fixed discharge outlet 20 to ensure safe operation of the pressurized reactor 12.

In one embodiment, a second temperature monitoring and control unit 19 may be installed on the upper part of the fixed discharge outlet 20 to monitor the temperature of the pressurized reactor 12 in real time. The steam input through the steam inlet 26 can be adjusted to maintain a constant temperature in the pressurized reactor 12.

In one embodiment, a second pressure monitoring and control unit 16 and a second exhaust unit 15 may be installed on the upper part of the fixed discharge outlet 20 to monitor and control internal pressure. In the event of a sudden pressure change, immediate pressure-control measures can be taken, facilitating process adjustment and research.

In summary, to address the issues of unstable product performance, low product quality, low added value, low efficiency, high energy consumption, and high cost in the related art for desulfurization gypsum quality improvement to produce α-hemihydrate gypsum, the embodiment of the disclosure proposes a segmented reactor for hydrothermal synthesis in desulfurization gypsum quality improvement. This reactor enables highly efficient mixing and reaction of materials. By employing multiple agitation modes, it ensures thorough contact and reaction between the steam and the desulfurization gypsum material, guaranteeing product uniformity and stability, improving reaction efficiency, and supporting research and process development for high-efficiency, high-quality, low-energy-consumption, and low-cost desulfurization gypsum quality improvement technologies.

The above description presents only illustrated embodiments of the disclosure and is not intended to limit the scope of the disclosure. Any modifications, equivalent substitutions, improvements, etc., made within the spirit and principles of the disclosure shall be included within the scope of protection of the disclosure.

1. A segmented reactor for hydrothermal synthesis in desulfurization gypsum quality improvement, comprising: a mixing and incubation device and a segmented pressurized reaction device sequentially connected and assembled in that order;
wherein the mixing and incubation device comprises:
a premixing reactor (3), defining a steam-injection feed inlet (2) and configured to preheat and mix steam with reaction feedstock;
a high-speed stirring and mixing component (4), disposed within the premixing reactor
(3) and configured to uniformly mix a gypsum slurry with the steam; and
a material conveying and dispersing component (5), disposed at a tail end of the premixing reactor (3) and configured to convey the gypsum slurry from the premixing reactor (3) to a pressurized reactor (12) while maintaining in a uniformly mixed state; and
wherein the segmented pressurized reaction device comprises:
the pressurized reactor (12), having a rotatable cylinder, wherein an interior of the rotatable cylinder defines a primary reaction zone and a residual reaction zone;
a material tumbling, dispersing and conveying component (14), fixed to an inner wall of the rotatable cylinder and configured to tumble, disperse, and convey the gypsum slurry; and
a steam spray component (13), rotatably mounted along an axial direction of the pressurized reactor (12), wherein the steam spray component (13) comprises a plurality of steam injection nozzles arranged along a movement direction of the gypsum slurry, a number of the steam injection nozzles in the primary reaction zone is greater than that in the residual reaction zone, and a distribution density of the steam injection nozzles in the primary reaction zone is greater than that in the residual reaction zone.

2. The segmented reactor for hydrothermal synthesis in desulfurization gypsum quality improvement as claimed in claim 1, wherein a height-diameter ratio of the premixing reactor (3) is in a range of 3:2 to 1:1.

3. The segmented reactor for hydrothermal synthesis in desulfurization gypsum quality improvement as claimed in claim 1, wherein a rotation direction of the steam spray component (13) is opposite to a rotation direction of the rotatable cylinder.

4. The segmented reactor for hydrothermal synthesis in desulfurization gypsum quality improvement as claimed in claim 1, wherein the material tumbling, dispersing and conveying component (14) comprises:
a plurality of baffles, circumferentially arranged on the inner wall of the rotatable cylinder; and
a plurality of internal helical ribbons, wherein each pair of the plurality of internal helical ribbons are disposed on opposite side walls of a corresponding one baffle of the plurality of baffles along the movement direction of the gypsum slurry and configured to convey the gypsum slurry in the movement direction of the gypsum slurry within the rotatable cylinder.

5. The segmented reactor for hydrothermal synthesis in desulfurization gypsum quality improvement as claimed in claim 4, wherein the plurality of internal helical ribbons are evenly spaced along the side walls of the plurality of baffles, and each internal helical ribbon is oriented at an acute angle relative to the movement direction of the gypsum slurry.

6. The segmented reactor for hydrothermal synthesis in desulfurization gypsum quality improvement as claimed in claim 1, wherein the steam spray component (13) comprises a steam conduit, an end of the steam conduit is rotatably connected to an end of the pressurized reactor (12), another end of the steam conduit is dynamically sealed to another end of the pressurized reactor (12), and the another end of the steam conduit extends outwardly from the pressurized reactor (12);
wherein the plurality of steam injection nozzles are alternately arranged on the steam conduit in a circumferential arrangement mode and connected to the steam conduit; and
wherein, along the movement direction of the gypsum slurry, a distribution density of the plurality of steam injection nozzles gradually decreases.

7. The segmented reactor for hydrothermal synthesis in desulfurization gypsum quality improvement as claimed in claim 1, further comprising a drive device, wherein the drive device comprises:
a first drive unit (23), disposed on a side of the rotatable cylinder and configured to rotate the rotatable cylinder; and
a second drive unit (24), disposed on an external portion of the steam spray component (13) extending out of the pressurized reactor (12), and configured to rotate the steam spray component (13).

8. The segmented reactor for hydrothermal synthesis in desulfurization gypsum quality improvement as claimed in claim 1, wherein the pressurized reactor (12) comprises a feed end cap and a discharge end cap respectively mounted at opposite ends of the rotatable cylinder and dynamically sealed to the rotatable cylinder;
wherein the feed end cap defines a feed inlet, and the discharge end cap defines a fixed discharge outlet (20); and the material conveying and dispersing component (5) of the mixing and incubation device is fixedly connected to the feed inlet.

9. The segmented reactor for hydrothermal synthesis in desulfurization gypsum quality improvement as claimed in claim 8, wherein the feed end cap is provided with a second dynamic sealing component (25), and the discharge end cap is provided with a support bearing component (18); an end of the steam spray component (13) is mounted on the support bearing component (18), and another end of the steam spray component (13) extends through the second dynamic sealing component (25); and
wherein, taking a horizontal direction as a reference, an included angle between an axial orientation of the pressurized reactor (12) and the horizontal direction is an acute angle.
